(19) United States
(12) Patent Application Publication
(10) Pub. No.: US 2024/0178383 A1
(43) Pub. Date: May 30, 2024

(54) ELECTRODE AND BATTERY

(71) Applicant: Panasonic Intellectual Property Management Co., Ltd., Osaka (JP)

(72) Inventors: AKIHIKO SAGARA, Nara (JP); TAKASHI OTO, Osaka (JP)

(21) Appl. No.: 18/431,997

(22) Filed: Feb. 4, 2024

Related U.S. Application Data
(63) Continuation of application No. PCT/JP2022/024464, filed on Jun. 20, 2022.

(30) Foreign Application Priority Data
Aug. 19, 2021 (JP) 2021-134338
Aug. 19, 2021 (JP) 2021-134339
Nov. 15, 2021 (JP) 2021-186027
Mar. 23, 2022 (JP) 2022-047187

(51) Int. Cl. H01M 4/485; H01M 4/131; H01M 4/505; H01M 4/525; H01M 10/0562; H01M 4/02

(52) U.S. Cl. CPC H01M 4/485; H01M 4/131; H01M 4/505; H01M 4/525; H01M 10/0562; H01M 2004/028; H01M 2300/008

(57) ABSTRACT

An electrode includes a current collector, a first electrode layer including a first active material containing Mo and O, and a second electrode layer including a second active material containing Li, Ti, and O. At least one selected from the group consisting of the first electrode layer and the second electrode layer includes a solid electrolyte.

### BACKGROUND

### 1. Technical Field

The present disclosure relates to an electrode and a battery.

### 2. Description of the Related Art

WO 2019/146295 discloses a negative electrode material that includes lithium titanate as a negative electrode active material and a halide solid electrolyte, and a battery using the same.

Japanese Unexamined Patent Application Publication No. 2021-34326 discloses an all-solid-state battery that includes lithium nickel cobalt manganese composite oxide as a positive electrode active material, lithium titanium oxide as a negative electrode active material, and a sulfide solid electrolyte.

### SUMMARY

In the conventional art, an electrode is desired that has a structure suited for satisfying both charge-discharge efficiency and discharge capacity.

In one general aspect, the techniques disclosed here feature an electrode including a current collector; a first electrode layer including a first active material containing Mo and O; and a second electrode layer including a second active material containing Li, Ti, and O. At least one selected from the group consisting of the first electrode layer and the second electrode layer includes a solid electrolyte.

The electrode provided according to the present disclosure has a structure suited for satisfying both charge-discharge efficiency and discharge capacity.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view illustrating a schematic configuration of an electrode according to Embodiment 1;

FIG. 2 is a sectional view illustrating a schematic configuration of an electrode according to Embodiment 2;

FIG. 3 is a sectional view illustrating a schematic configuration of a battery according to Embodiment 3;

FIG. 4 is a sectional view illustrating a schematic configuration of a battery according to Embodiment 4;

FIG. 5 is a sectional view illustrating a schematic configuration of a battery according to Modification 1;

FIG. 6 is a sectional view illustrating a schematic configuration of a battery according to Modification 2;

FIG. 7 is a sectional view illustrating a schematic configuration of a battery according to Modification 3;

FIG. 8 is a sectional view illustrating a schematic configuration of a battery according to Embodiment 5;

FIG. 9 is a sectional view illustrating a schematic configuration of a battery according to Embodiment 6; and

FIG. 10 is a graph illustrating results of a discharge test of batteries of EXAMPLES 1 and 2 and REFERENCE EXAMPLE 1.

### DETAILED DESCRIPTIONS

### Underlying Knowledge Forming Basis of the Present Disclosure

WO 2019/146295 discloses a battery that uses a negative electrode material including lithium titanate as a negative electrode active material. Batteries using lithium titanate are known to exhibit high charge-discharge efficiency. Furthermore, lithium titanate is unlikely to cause deposition of lithium metal. Thus, the use of lithium titanate in a negative electrode makes it possible to prevent an internal short circuit caused by the metal deposits penetrating an electrolyte layer and coming into contact with a positive electrode. Furthermore, lithium titanate is characterized by its small expansion and contraction associated with insertion and extraction of lithium ions. Thus, the use of lithium titanate as an active material can enhance the battery safety. On the other hand, lithium titanate disadvantageously has a small capacity per unit mass.

The present inventors carried out extensive studies on structures suited for satisfying both charge-discharge efficiency and discharge capacity, and have developed an electrode of the present disclosure as a result.

### SUMMARY OF ASPECTS OF THE PRESENT DISCLOSURE

An electrode according to the first aspect of the present disclosure includes: a current collector; a first electrode layer including a first active material containing Mo and O; and a second electrode layer including a second active material containing Li, Ti, and O. At least one selected from the group consisting of the first electrode layer and the second electrode layer includes solid electrolyte.

The first electrode layer that includes a first active material containing Mo and O enhances the battery discharge capacity. The second electrode layer that includes a second active material containing Li, Ti, and O enhances the battery charge-discharge efficiency. Thus, the structure of the electrode according to the above configuration is suited for satisfying both charge-discharge efficiency and discharge capacity. Furthermore, at least one selected from the group consisting of the first electrode layer and the second electrode layer includes a solid electrolyte, and the battery heat resistance and the battery safety can be enhanced as a result.

In the second aspect of the present disclosure, for example, the electrode according to the first aspect may include the current collector, the first electrode layer, and the second electrode layer in this order. It is known that a battery using an active material containing Li, Ti, and O has a small change in discharge potential during discharging. It is also a known fact that a battery using an active material containing Mo and O has a larger change in discharge potential during discharging than a battery using an active material containing Li, Ti, and O. According to the above configuration, the second electrode layer including the second active material is arranged on the electrolyte layer side in a battery, and thus the change in average discharge voltage may be reduced. As a result, the change in battery operating voltage is reduced.

In the third aspect of the present disclosure, for example, the electrode according to the first aspect may include the current collector, the second electrode layer, and the first electrode layer in this order. According to this configuration, both charge-discharge efficiency and discharge capacity can be satisfied.

In the fourth aspect of the present disclosure, for example, the electrode according to any one of the first to the third aspects may be such that the first active material includes molybdenum oxide. According to this configuration, both charge-discharge efficiency and discharge capacity are satisfied more reliably.

In the fifth aspect of the present disclosure, for example, the electrode according to the fourth aspect may be such that the molybdenum oxide includes MoO₂. According to this configuration, both charge-discharge efficiency and discharge capacity are satisfied more reliably.

In the sixth aspect of the present disclosure, for example, the electrode according to any one of the first to the fifth aspects may be such that the second active material includes lithium titanium oxide. According to this configuration, both charge-discharge efficiency and discharge capacity are satisfied more reliably.

In the seventh aspect of the present disclosure, for example, the electrode according to the sixth aspect may be such that the lithium titanium oxide includes Li₄Ti₅O₁₂. According to this configuration, both charge-discharge efficiency and discharge capacity are satisfied more reliably.

In the eighth aspect of the present disclosure, for example, the electrode according to any one of the first to the seventh aspects may be such that the solid electrolyte contains Li, M, and X. M is at least one selected from the group consisting of metal elements other than Li, and metalloid elements. X is at least one selected from the group consisting of F, Cl, Br, and I. According to this configuration, battery output characteristics can be enhanced.

In the ninth aspect of the present disclosure, for example, the electrode according to the eighth aspect may be such that the solid electrolyte is represented by following formula (1):

Li_{α}M_{β}X_{γ} Formula (1)

Here, α, β, and γ are each independently a value greater than 0. According to this configuration, battery output characteristics can be further enhanced.

In the tenth aspect of the present disclosure, for example, the electrode according to the ninth aspect may be such that the solid electrolyte includes Li₃YBr₂Cl₂I₂. According to this configuration, battery output characteristics can be further enhanced.

In the eleventh aspect of the present disclosure, for example, the electrode according to any one of the eighth to the tenth aspects may be such that the solid electrolyte does not contain sulfur. According to this configuration, the battery safety can be enhanced.

A battery according to the twelfth aspect of the present disclosure includes: a positive electrode; a negative electrode; and an electrolyte layer arranged between the positive electrode and the negative electrode. The positive electrode or the negative electrode includes the electrode according to any one of the first to the eleventh aspects.

The battery according to the above configuration can satisfy both charge-discharge efficiency and discharge capacity. Furthermore, the battery may attain a smaller change in average discharge voltage.

In the thirteenth aspect of the present disclosure, for example, the battery according to the twelfth aspect may be such that the positive electrode includes a positive electrode active material, the negative electrode includes the first electrode layer and the second electrode layer, and the ratio of the area occupied by the first active material in a cross section of the first electrode layer to the area occupied by the positive electrode active material in a cross section of the positive electrode is greater than or equal to 1% and less than or equal to 50%. The first active material containing Mo and O has charge-discharge potentials close to those of the second active material containing Li, Ti, and O. Thus, the combined use of the first active material and the second active material does not significantly impair the shape of battery charge-discharge curves. Furthermore, the first active material containing Mo and O has a characteristic that it contracts during charging and expands during discharging. That is, the first electrode layer expands and contracts along with the expansion and contraction of the positive electrode during charging and discharging, and thus serves to reduce the expansion and contraction of the battery as a whole. Thus, the battery according to the above configuration attains enhanced cycle characteristics.

In the fourteenth aspect of the present disclosure, for example, the battery according to the thirteenth aspect may be such that the ratio is greater than or equal to 1% and less than or equal to 30%. According to this configuration, cycle characteristics can be further enhanced.

In the fifteenth aspect of the present disclosure, for example, the battery according to the fourteenth aspect may be such that the ratio is greater than or equal to 10% and less than or equal to 20%. According to this configuration, cycle characteristics can be further enhanced.

In the sixteenth aspect of the present disclosure, for example, the battery according to any one of the thirteenth to the fifteenth aspects may be such that the ratio of the charge capacity of the first electrode layer to the charge capacity of the second electrode layer is less than or equal to 0.4. According to this configuration, cycle characteristics can be further enhanced.

In the seventeenth aspect of the present disclosure, for example, the battery according to any one of the thirteenth to the sixteenth aspects may be such that the positive electrode active material includes lithium nickel cobalt manganate. According to this configuration, the battery can attain enhancements in energy density and charge-discharge efficiency.

In the eighteenth aspect of the present disclosure, for example, the battery according to the seventeenth aspect may be such that the positive electrode active material includes LiNi_{0.6}Co_{0.2}Mn_{0.2}O₂. According to this configuration, the battery can attain enhancements in energy density and charge-discharge efficiency.

In the nineteenth aspect of the present disclosure, for example, the battery according to any one of the twelfth to the eighteenth aspects may be such that the positive electrode includes a solid electrolyte, and the solid electrolyte contains Li, M, and X. M is at least one selected from the group consisting of metal elements other than Li, and metalloid elements; and X is at least one selected from the group consisting of F, Cl, Br, and I. According to this configuration, the battery can attain enhanced output characteristics.

Hereinafter, embodiments of the present disclosure will be described with reference to the drawings.

### Embodiment 1

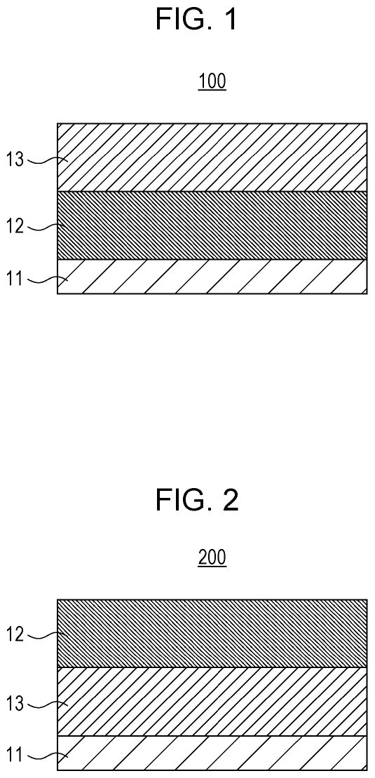

FIG. 1 is a sectional view illustrating a schematic configuration of an electrode 100 according to Embodiment 1.

The electrode 100 includes a current collector 11, a first electrode layer 12, and a second electrode layer 13 in this order. The first electrode layer 12 is arranged between the current collector 11 and the second electrode layer 13. The first electrode layer 12 includes a first active material containing Mo and O. The second electrode layer 13 includes a second active material containing Li, Ti, and O. At least one selected from the group consisting of the first electrode layer 12 and the second electrode layer 13 includes a solid electrolyte.

In the electrode 100, the current collector 11 and the first electrode layer 12 may be in direct contact. In the electrode 100, the first electrode layer 12 and the second electrode layer 13 may be in direct contact.

The first electrode layer 12 includes the first active material containing Mo and O and thereby enhances the battery discharge capacity. The second electrode layer 13 includes the second active material containing Li, Ti, and O and thereby enhances the battery charge-discharge efficiency. Thus, the electrode provided according to the above configuration has a structure suited for satisfying both charge-discharge efficiency and discharge capacity.

It is known that a battery using an active material containing Li, Ti, and O has a small change in discharge potential during discharging. It is also a known fact that a battery using an active material containing Mo and O has a larger change in discharge potential during discharging than a battery using an active material containing Li, Ti, and O. According to the configuration described above, the second electrode layer 13 including the second active material is arranged on the electrolyte layer side in a battery, and thus the change in average discharge voltage may be reduced. As a result, the change in battery operating voltage is reduced.

The first electrode layer 12 may include the first active material alone as the active material. In the present disclosure, the phrase “include the first active material alone” means that materials other than the first active material, except incidental impurities, are not intentionally added as active materials to the first electrode layer 12. For example, incidental impurities include ingredients for the first active material, and by-products occurring during preparation of the first active material. The same applies to other materials.

The first active material may include molybdenum oxide. According to this configuration, both charge-discharge efficiency and discharge capacity are satisfied more reliably.

The first active material may include molybdenum oxide as a main component. In the present disclosure, the term “main component” means that the component represents a mass ratio of greater than or equal to 50%.

The first active material may include molybdenum oxide in a mass ratio of greater than or equal to 70% relative to the whole of the first active material.

The first active material may be molybdenum oxide.

Examples of the molybdenum oxides include MoO₂.

The molybdenum oxide may include MoO₂. According to the above configurations, both charge-discharge efficiency and discharge capacity are satisfied more reliably.

The molybdenum oxide may be MoO₂.

The second electrode layer 13 may include the second active material alone as the active material.

The second active material may include lithium titanium oxide. According to the above configurations, both charge-discharge efficiency and discharge capacity are satisfied more reliably.

The second active material may include lithium titanium oxide as a main component.

The second active material may include lithium titanium oxide in a mass ratio of greater than or equal to 70% relative to the whole of the second active material.

The second active material may be lithium titanium oxide.

Examples of the lithium titanium oxides include Li₄Ti₅O₁₂, Li₇Ti₅O₁₂, and LiTi₂O₄. When the second active material includes lithium titanium oxide, the lithium titanium oxide may include at least one selected from these materials.

The lithium titanium oxide may include Li₄Ti₅O₁₂. According to the above configurations, both charge-discharge efficiency and discharge capacity are satisfied more reliably.

The lithium titanium oxide may be Li₄Ti₅O₁₂.

The first electrode layer 12 may include a solid electrolyte. According to this configuration, the battery heat resistance and the battery safety can be enhanced.

The second electrode layer 13 may include a solid electrolyte. According to this configuration, the battery heat resistance and the battery safety can be enhanced.

The solid electrolyte that may be contained in the first electrode layer 12 and the second electrode layer 13 is written as the first solid electrolyte.

The first solid electrolyte that is used may be a halide solid electrolyte, a sulfide solid electrolyte, an oxide solid electrolyte, a polymeric solid electrolyte, or a complex hydride solid electrolyte.

The first solid electrolyte may contain Li, M, and X. Here, M is at least one selected from the group consisting of metal elements other than Li, and metalloid elements. X is at least one selected from the group consisting of F, Cl, Br, and I. According to this configuration, the first solid electrolyte can attain enhanced ion conductivity and thereby can offer enhanced battery output characteristics.

In the present disclosure, the “metalloid elements” are B, Si, Ge, As, Sb, and Te. The “metal elements” indicate all the elements found in Groups 1 to 12 of the periodic table other than hydrogen, and all the elements found in Groups 13 to 16 of the periodic table other than B, Si, Ge, As, Sb, Te, C, N, P, O, S, and Se. That is, the “metalloid elements” or the “metal elements” are a group of elements that can form an inorganic compound with a halogen element by becoming a cation.

The first solid electrolyte may consist essentially of Li, M, and X. The phrase “consist essentially of Li, M, and X” means that the molar ratio (that is, the molar fraction) of the total of the amounts of substance of Li, M, and X in the first solid electrolyte to the total of the amounts of substance of all the elements constituting the first solid electrolyte is greater than or equal to 90%. As an example, the molar ratio may be greater than or equal to 95%.

The first solid electrolyte may contain only Li, M, and X.

The first solid electrolyte may be represented by the following formula (1):

Li_{α}M_{β}X_{γ} Formula (1)

In the formula (1), α, β, and γ are each independently a value greater than 0. According to the above configuration, the first solid electrolyte can attain still enhanced ion conductivity and thereby can offer further enhanced battery output characteristics.

When the first solid electrolyte contains Li, M, and X, M may include at least one selected from the group consisting of Group 1 elements, Group 2 elements, Group 3 elements, Group 4 elements, and lanthanoid elements. According to this configuration, the ion conductivity of the first solid electrolyte can be further enhanced.

Examples of the Group 1 elements include Na, K, Rb, and Cs. Examples of the Group 2 elements include Mg, Ca, Sr, and Ba. Examples of the Group 3 elements include Sc and Y. Examples of the Group 4 elements include Ti, Zr, and Hf. Examples of the lanthanoid elements include La, Ce, Pr, Nd, Sm, Eu, Gd, Tb, Dy, Ho, Er, Tm, Yb, and Lu.

When the first solid electrolyte contains Li, M, and X, M may include at least one selected from the group consisting of Group 5 elements, Group 12 elements, Group 13 elements, and Group 14 elements. According to this configuration, the ion conductivity of the first solid electrolyte can be further enhanced.

Examples of the Group 5 elements include Nb and Ta. Examples of the Group 12 elements include Zn. Examples of the Group 13 elements include Al, Ga, and In. Examples of the Group 14 elements include Sn.

When the first solid electrolyte contains Li, M, and X, M may include at least one selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu. According to this configuration, the ion conductivity of the first solid electrolyte can be further enhanced.

When the first solid electrolyte contains Li, M, and X, M may include at least one selected from the group consisting of Mg, Ca, Sr, Y, Sm, Gd, Dy, and Hf. According to this configuration, the ion conductivity of the first solid electrolyte can be further enhanced.

When the first solid electrolyte contains Li, M, and X, X may include at least one selected from the group consisting of Br, Cl, and I. According to this configuration, the ion conductivity of the first solid electrolyte can be further enhanced.

When the first solid electrolyte contains Li, M, and X, X may include Br, Cl, and I. According to this configuration, the ion conductivity of the first solid electrolyte can be further enhanced.

When the first solid electrolyte contains Li, M, and X, M may include Y (=yttrium). That is, the first solid electrolyte may contain Y as a metal element. According to this configuration, the ion conductivity of the first solid electrolyte can be further enhanced.

When the first solid electrolyte contains Li, M, and X, M may be Y (=yttrium).

When the first solid electrolyte contains Y, the first solid electrolyte may be represented by the following formula (2):

Li₃YX₆ Formula (2)

In the formula (2), X is at least one selected from the group consisting of F, Cl, Br, and I.

When the first solid electrolyte contains Y, the first solid electrolyte may be represented by the following formula (3):

Li₃YBrₓCl₆₋ₓ Formula (3)

In the formula (3), 0≤x≤6 is satisfied.

When the first solid electrolyte contains Y, the first solid electrolyte may be represented by the following formula (4):

Li₃YBrₓCl_{y}I_{6-x-y} Formula (4)

In the formula (4), 0≤x≤6 and 0≤y≤6 are satisfied.

More specifically, the first solid electrolyte may include at least one selected from the group consisting of Li₃YCl₆, Li₃YBr₆, Li₃YBr₂Cl₄, and Li₃YBr₂Cl₂I₂.

The first solid electrolyte may include Li₃YBr₂Cl₂I₂. According to the above configurations, the first solid electrolyte can attain still enhanced ion conductivity and thus can offer further enhanced battery output characteristics.

The first solid electrolyte may include Li₃YBr₂Cl₂I₂ as a main component.

The first solid electrolyte may include Li₃YBr₂Cl₂I₂ in a mass ratio of greater than or equal to 70% relative to the whole of the first solid electrolyte.

The first solid electrolyte may be Li₃YBr₂Cl₂I₂.

Examples of the sulfide solid electrolytes that may be used include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. For example, LiX, Li₂O, MO_{q}, and LiₚMO_{q} may be added to those described above. Here, X includes at least one selected from the group consisting of F, Cl, Br, and I. M includes at least one selected from the group consisting of P, Si, Ge, B, Al, Ga, In, Fe, and Zn. The letters p and q are each a natural number. One, or two or more sulfide solid electrolytes selected from the above materials may be used.

Examples of the oxide solid electrolytes that may be used include NASICON-type solid electrolytes typified by LiTi₂(PO₄)₃ and element-substituted derivatives thereof; (LaLi)TiO₃ perovskite-type solid electrolytes; LISICON-type solid electrolytes typified by Li₁₄ZnGe₄O₁₆, Li₄SiO₄, LiGeO₄, and element-substituted derivatives thereof; garnet-type solid electrolytes typified by Li₇La₃Zr₂O₁₂ and element-substituted derivatives thereof; Li₃N and H-substituted derivatives thereof; Li₃PO₄ and N-substituted derivatives thereof; and glass and glass ceramics based on Li—B—O compound, such as LiBO₂ or Li₃BO₃ and doped with, for example, Li₂SO₄ or Li₂CO₃.

For example, the polymeric solid electrolyte that is used may be a compound of a polymer compound with a lithium salt. The polymer compound may have an ethylene oxide structure. The polymer compound having an ethylene oxide structure can contain a large amount of a lithium salt, and thus the ion conductivity can be further increased. Examples of the lithium salts that may be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One, or two or more lithium salts selected from the above lithium salts may be used.

Examples of the complex hydride solid electrolytes that may be used include LiBH₄—LiI and LiBH₄—P₂S₅.

The first solid electrolyte may not contain sulfur. This configuration can eliminate the generation of hydrogen sulfide gas and thus can enhance the battery safety.

The composition of the first solid electrolyte contained in the first electrode layer 12 and the composition of the first solid electrolyte contained in the second electrode layer 13 may be the same as or different from each other.

The shape of the first solid electrolyte is not limited. For example, the shape of the first solid electrolyte may be acicular, spherical, ellipsoidal, or fibers. For example, the shape of the first solid electrolyte may be particulate. The first solid electrolyte may be formed to have a pellet or plate shape.

When the first solid electrolyte is particles (for example, spherical particles), the median diameter of the first solid electrolyte may be greater than or equal to 0.1 μm and less than or equal to 100 μm. According to this configuration, the first active material and the first solid electrolyte may be favorably dispersed in the first electrode layer 12; furthermore, the second active material and the first solid electrolyte may be favorably dispersed in the second electrode layer 13. Thus, battery charge-discharge characteristics are enhanced.

In the present disclosure, the “median diameter” means the particle size at 50% cumulative volume in the volume-based grain size distribution. For example, the volume-based grain size distribution is measured with a laser diffraction measurement device or an image analyzer.

The median diameter of the first solid electrolyte may be greater than or equal to 0.5 μm and less than or equal to 10 μm. According to this configuration, the first active material and the first solid electrolyte may be more favorably dispersed in the first electrode layer 12; furthermore, the second active material and the first solid electrolyte may be more favorably dispersed in the second electrode layer 13.

The shapes of the first active material and the second active material are not limited. Specifically, for example, the shapes of the first active material and the second active material may be acicular, spherical, or ellipsoidal. For example, the shapes of the first active material and the second active material may be particulate.

When the first active material and the second active material are particles (for example, spherical particles), the median diameters of the first active material and the second active material may be each greater than or equal to 0.1 μm and less than or equal to 100 μm. When the median diameters of the first active material and the second active material are each greater than or equal to 0.1 μm, the first active material and the first solid electrolyte may be favorably dispersed in the first electrode layer 12; furthermore, the second active material and the first solid electrolyte may be favorably dispersed in the second electrode layer 13. Thus, battery charge-discharge characteristics are enhanced. When the median diameters of the first active material and the second active material are each less than or equal to 100 μm, the lithium diffusion rate in the inside of the first active material and the second active material is enhanced, thus allowing a battery to be operated at a high output.

The median diameters of the first active material and the second active material may be larger than the median diameter of the first solid electrolyte. According to this configuration, the first active material and the first solid electrolyte may be favorably dispersed in the first electrode layer 12; furthermore, the second active material and the first solid electrolyte may be favorably dispersed in the second electrode layer 13.

At least one selected from the group consisting of the first active material and the second active material may be coated with a coating material. Both the first active material and the second active material may be coated with a coating material. Either the first active material or the second active material may be coated with a coating material.

A material with low electron conductivity may be used as the coating material. Examples of the coating materials that may be used include oxide materials and oxide solid electrolytes.

Examples of the oxide materials that may be used include SiO₂, Al₂O₃, TiO₂, B₂O₃, Nb₂O₅, WO₃, and ZrO₂.

Examples of the oxide solid electrolytes that may be used as the coating materials include Li—Nb—O compounds, such as LiNbO₃; Li—B—O compounds, such as LiBO₂ and Li₃BO₃; Li—Al—O compounds, such as LiAlO₂; Li—Si—O compounds, such as Li₄SiO₄; Li₂SO₄; Li—Ti—O compounds, such as Li₄Ti₅O₁₂; Li—Zr—O compounds, such as Li₂ZrO₃; Li—Mo—O compounds, such as Li₂MoO₃; Li—V—O compounds, such as LiV₂O₅; and Li—W—O compounds, such as Li₂WO₄.

The coating material may be an oxide solid electrolyte.

Oxide solid electrolytes have high ion conductivity. Oxide solid electrolytes have excellent high-potential stability. Thus, battery charge-discharge efficiency can be further enhanced by using an oxide solid electrolyte as the coating material.

The coating material may uniformly cover the first active material and/or the second active material. In this case, the coating material keeps the first active material and/or the second active material away from direct contact with the first solid electrolyte and thus can suppress side reactions of the first solid electrolyte. Thus, battery charge-discharge efficiency can be enhanced.

The coating material may cover part of the first active material and/or part of the second active material. Particles of the first active material and/or particles of the second active material are placed in direct contact through portions exposed from the coating material, and the electron conductivity is enhanced between particles of the first active material and/or particles of the second active material, thus allowing a battery to be operated at a high output.

The electrode 100 may have a structure in which the first electrode layers 12 and the second electrode layers 13 are alternately laminated a plurality of times. That is, the first electrode layer 12 and the second electrode layer 13 may be laminated one time, or two or more times in the electrode 100.

When the electrode 100 has a structure in which the first electrode layers 12 and the second electrode layers 13 are alternately laminated a plurality of times, the compositions of the first active materials contained in the first electrode layers 12 may be the same as or different from one another, and the compositions of the second active materials contained in the second electrode layers 13 may be the same as or different from one another.

In the first electrode layer 12, the first active material and the first solid electrolyte may be in contact with each other.

The first electrode layer 12 may include particles of the first active material and particles of the first solid electrolyte.

In the first electrode layer 12, the content of the first active material and the content of the first solid electrolyte may be equal to or different from each other.

The volume ratio “v1:100−v1” between the first active material and the first solid electrolyte present in the first electrode layer 12 may satisfy 5≤v1≤95. Here, v1 indicates the volume proportion of the first active material relative to the total volume of the first active material and the first solid electrolyte in the first electrode layer 12 taken as 100. When 5≤v1 is satisfied, a sufficient battery energy density may be ensured. When v1≤95 is satisfied, a battery may be operated at a high output.

The thickness of the first electrode layer 12 may be greater than or equal to 0.2 μm and less than or equal to 2000 μm. When the thickness of the first electrode layer 12 is greater than or equal to 0.2 μm, a sufficient battery energy density may be ensured. When the thickness of the first electrode layer 12 is less than or equal to 2000 μm, a battery may be operated at a high output. The thickness of the first electrode layer 12 may be greater than or equal to 1 μm and less than or equal to 2000 μm.

In the second electrode layer 13, the second active material and the first solid electrolyte may be in contact with each other.

The second electrode layer 13 may include particles of the second active material and particles of the first solid electrolyte.

In the second electrode layer 13, the content of the second active material and the content of the first solid electrolyte may be equal to or different from each other.

The volume ratio “v2:100−v2” between the second active material and the first solid electrolyte present in the second electrode layer 13 may satisfy 5≤v2≤95. Here, v2 indicates the volume proportion of the second active material relative to the total volume of the second active material and the first solid electrolyte in the second electrode layer 13 taken as 100. When 5≤v2 is satisfied, a sufficient battery energy density may be ensured. When v2≤95 is satisfied, a battery may be operated at a high output.

The thickness of the second electrode layer 13 may be greater than or equal to 0.2 μm and less than or equal to 2000 μm. When the thickness of the second electrode layer 13 is greater than or equal to 0.2 μm, a sufficient battery energy density may be ensured. When the thickness of the second electrode layer 13 is less than or equal to 2000 μm, a battery may be operated at a high output. The thickness of the second electrode layer 13 may be greater than or equal to 1 μm and less than or equal to 2000 μm.

For example, the current collector 11 that is used may be a sheet or a film made of a conductive metal material. Examples of the conductive metal materials include aluminum, stainless steel, titanium, and alloys thereof. Examples of the sheets or the films include metal foils and meshes. The current collector 11 may be a stainless-steel sheet.

The thickness of the current collector 11 may be greater than or equal to 5 μm and less than or equal to 100 μm. When the thickness of the current collector 11 is greater than or equal to 5 μm, sufficient mechanical strength may be ensured. When the thickness of the current collector 11 is less than or equal to 100 μm, the decrease in battery energy density is small.

### Electrode Producing Methods

For example, the electrode 100 may be produced by the following method.

A first electrode material is obtained by mixing a first active material and a first solid electrolyte. The first active material and the first solid electrolyte may be mixed in any manner without limitation. For example, the first active material and the first solid electrolyte may be mixed using a tool, such as a mortar, or the first active material and the first solid electrolyte may be mixed using a mixing device, such as a ball mill. The first active material and the first solid electrolyte may be mixed in any ratio without limitation.

A second electrode material is obtained by mixing a second active material and a first solid electrolyte. The second active material and the first solid electrolyte may be mixed in any manner without limitation. For example, the second active material and the first solid electrolyte may be mixed using a tool, such as a mortar, or the second active material and the first solid electrolyte may be mixed using a mixing device, such as a ball mill. The second active material and the first solid electrolyte may be mixed in any ratio without limitation.

A stainless-steel sheet is provided as a current collector 11. The first electrode material and the second electrode material are laminated in this order onto the current collector 11 by a known method. An electrode 100 including a current collector 11, a first electrode layer 12, and a second electrode layer 13 in this order can be thus obtained.

The first electrode material and the second electrode material may be alternately laminated a plurality of times. That is, the first electrode layer 12 and the second electrode layer 13 may be laminated one time, or two or more times in the electrode 100.

For example, the first solid electrolyte may be produced by the following method.

Ingredient powders are provided in a blend ratio corresponding to the target composition. For example, the ingredient powders may be halides. When, for example, Li₃YBr₂Cl₄ is prepared as the first solid electrolyte, LiBr, LiCl, and YCl₃ are provided in a molar ratio of 2.0:1.0:1.0. The ingredient powders may be mixed in a molar ratio controlled beforehand so as to compensate for compositional changes expected in the synthesis process.

The kinds of the ingredient powders are not limited to those described above. For example, use may be made of a combination of LiCl and YBr₃, or a composite anion compound, such as LiBr_{0.5}Cl_{0.5}. A mixture of an oxygen-containing ingredient powder and a halide may also be used. Examples of the oxygen-containing ingredient powders include oxides, hydroxides, sulfates, and nitrates. Examples of the halides include ammonium halides.

The ingredient powders are sufficiently mixed using a mortar and a pestle, a ball mill, or a mixer to give a mixed powder. Next, the mixed powder is pulverized using a mechanochemical milling technique. In this manner, the ingredient powders react to give a first solid electrolyte. Alternatively, the ingredient powders that have been sufficiently mixed may be heat-treated in vacuum or in an inert atmosphere to give a first solid electrolyte.

For example, the heat treatment may be performed in the range of temperatures higher than or equal to 100° C. and lower than or equal to 650° C. for at least 1 hour. The first solid electrolyte containing a crystal phase is thus obtained.

The configuration of the crystal phase (namely, the crystal structure) in the first solid electrolyte may depend on the elements constituting the first solid electrolyte (for example, M and X), the ratio of the constituent elements in the first solid electrolyte, the manner in which the ingredient powders are reacted, and reaction conditions that are selected.

### Embodiment 2

Embodiment 2 will be described below with reference to FIG. 2. The same reference numerals are assigned to the same constituent members as in Embodiment 1, and detailed description thereof is omitted.

FIG. 2 is a sectional view illustrating a schematic configuration of an electrode 200 according to Embodiment 2.

The electrode 200 includes a current collector 11, a second electrode layer 13, and a first electrode layer 12 in this order. The second electrode layer 13 is arranged between the current collector 11 and the first electrode layer 12. The first electrode layer 12 includes a first active material containing Mo and O. The second electrode layer 13 includes a second active material containing Li, Ti, and O.

In the electrode 200, the current collector 11 and the second electrode layer 13 may be in direct contact. In the electrode 200, the first electrode layer 12 and the second electrode layer 13 may be in direct contact.

The first electrode layer 12 includes the first active material containing Mo and O and thereby enhances the battery discharge capacity. The second electrode layer 13 includes the second active material containing Li, Ti, and O and thereby enhances the battery charge-discharge efficiency. Thus, the above configuration too can satisfy both charge-discharge efficiency and discharge capacity.

### Embodiment 3

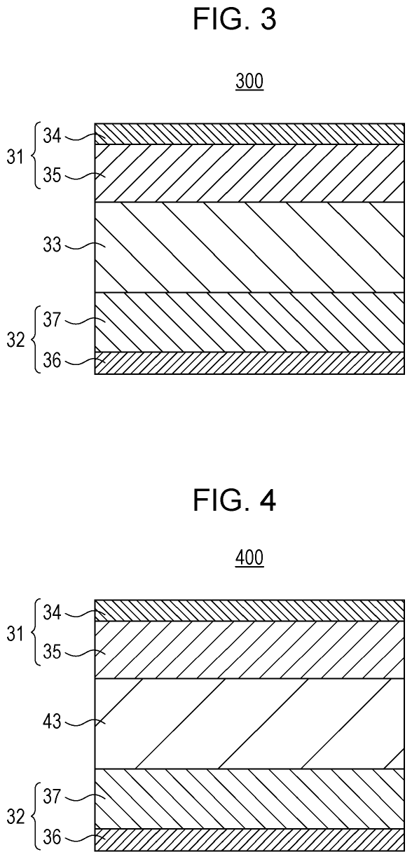

Embodiment 3 will be described below with reference to FIG. 3. Descriptions overlapping with those of Embodiments 1 and 2 are omitted as appropriate.

FIG. 3 is a sectional view illustrating a schematic configuration of a battery 300 according to Embodiment 3.

The battery 300 includes a positive electrode 31, a negative electrode 32, and an electrolyte layer 33. The positive electrode 31 or the negative electrode 32 includes the electrode 100 in Embodiment 1 or the electrode 200 in Embodiment 2.

According to the above configuration, the battery 300 can satisfy both charge-discharge efficiency and discharge capacity. Furthermore, the battery 300 may attain a small change in average discharge voltage.

The positive electrode 31 includes a positive electrode current collector 34 and a positive electrode layer 35. The negative electrode 32 includes a negative electrode current collector 36 and a negative electrode layer 37. The electrolyte layer 33 is arranged between the positive electrode 31 and the negative electrode 32 in such a manner that the positive electrode current collector 34 and the negative electrode current collector 36 are the outermost layers.

In the battery 300, the positive electrode current collector 34 and the positive electrode layer 35 may be in direct contact. In the battery 300, the negative electrode current collector 36 and the negative electrode layer 37 may be in direct contact. Furthermore, in the battery 300, the electrolyte layer 33 may be in direct contact with the positive electrode layer 35 and the negative electrode layer 37.

The positive electrode 31 may include the electrode 100. In this case, the positive electrode current collector 34 corresponds to the current collector 11, and the positive electrode layer 35 corresponds to the first electrode layer 12 and the second electrode layer 13. In this case, the second electrode layer 13 may be in direct contact with the electrolyte layer 33.

The positive electrode 31 may include the electrode 200. In this case, the positive electrode current collector 34 corresponds to the current collector 11, and the positive electrode layer 35 corresponds to the first electrode layer 12 and the second electrode layer 13. In this case, the first electrode layer 12 may be in direct contact with the electrolyte layer 33.

The negative electrode 32 may include the electrode 100. In this case, the negative electrode current collector 36 corresponds to the current collector 11, and the negative electrode layer 37 corresponds to the first electrode layer 12 and the second electrode layer 13. In this case, the second electrode layer 13 may be in direct contact with the electrolyte layer 33.

The negative electrode 32 may include the electrode 200. In this case, the negative electrode current collector 36 corresponds to the current collector 11, and the negative electrode layer 37 corresponds to the first electrode layer 12 and the second electrode layer 13. In this case, the first electrode layer 12 may be in direct contact with the electrolyte layer 33.

The positive electrode 31 may be the electrode 100 or the electrode 200.

The negative electrode 32 may be the electrode 100 or the electrode 200.

The electrolyte layer 33 is a layer including an electrolyte. For example, the electrolyte is a solid electrolyte. That is, the electrolyte layer 33 may be a solid electrolyte layer.

The solid electrolyte contained in the electrolyte layer 33 is written as the second solid electrolyte. The second solid electrolyte that is used may be a halide solid electrolyte, a sulfide solid electrolyte, an oxide solid electrolyte, a polymeric solid electrolyte, or a complex hydride solid electrolyte.

For example, the halide solid electrolyte, the sulfide solid electrolyte, the oxide solid electrolyte, the polymeric solid electrolyte, or the complex hydride solid electrolyte that is used may be a material described as the first solid electrolyte in Embodiment 1. That is, the second solid electrolyte contained in the electrolyte layer 33 may have the same composition as that of the first solid electrolyte. According to the above configuration, the charge-discharge efficiency of the battery 300 can be further enhanced.

The second solid electrolyte contained in the electrolyte layer 33 may include a halide solid electrolyte having a composition different from that of the first solid electrolyte.

The second solid electrolyte contained in the electrolyte layer 33 may include a combination of two or more halide solid electrolytes selected from the materials described as the first solid electrolytes.

The second solid electrolyte contained in the electrolyte layer 33 may include only one halide solid electrolyte selected from the materials described as the first solid electrolytes.

The electrolyte layer 33 may include the second solid electrolyte as a main component.

The electrolyte layer 33 may include the second solid electrolyte in a mass ratio of greater than or equal to 70% relative to the whole of the electrolyte layer 33.

The electrolyte layer 33 may include only the second solid electrolyte.

The electrolyte layer 33 may include two or more of the materials described above as the second solid electrolytes.

The shape of the second solid electrolyte is not limited. For example, the shape of the second solid electrolyte may be acicular, spherical, ellipsoidal, or fibers. For example, the shape of the second solid electrolyte may be particulate. The second solid electrolyte may be formed to have a pellet or plate shape.

When the second solid electrolyte is particles (for example, spherical particles), the median diameter of the second solid electrolyte may be greater than or equal to 0.1 μm and less than or equal to 100 μm. According to this configuration, the ion conductivity of the second solid electrolyte can be enhanced. Furthermore, the second solid electrolyte and other materials may be favorably dispersed in the electrolyte layer 33. Thus, the battery 300 attains enhanced charge-discharge characteristics.

The median diameter of the second solid electrolyte may be greater than or equal to 0.5 μm and less than or equal to 10 μm. According to this configuration, the ion conductivity of the second solid electrolyte can be further enhanced.

The thickness of the electrolyte layer 33 may be greater than or equal to 1 μm and less than or equal to 1000 μm. When the thickness of the electrolyte layer 33 is greater than or equal to 1 μm, the positive electrode layer 35 and the negative electrode layer 37 are unlikely to be short circuited. When the thickness of the electrolyte layer 33 is less than or equal to 1000 μm, the battery 300 may be operated at a high output.

When the positive electrode 31 includes the electrode 100 or the electrode 200, the positive electrode layer 35 may further include an active material other than the first active material and the second active material. The positive electrode layer 35 may include a positive electrode active material.

When the positive electrode 31 does not include the electrode 100 or the electrode 200, the positive electrode layer 35 may include only a positive electrode active material as the active material.

For example, the positive electrode active material includes a material capable of occluding and releasing metal ions, such as lithium ions.

Examples of the positive electrode active materials include lithium-containing transition metal oxides, transition metal fluorides, polyanion materials, fluorinated polyanion materials, transition metal sulfides, transition metal oxysulfides, and transition metal oxynitrides. Examples of the lithium-containing transition metal oxides include Li(Ni,Co,Al)O₂, Li(Ni,Co,Mn)O₂, and LiCoO₂. In particular, the use of a lithium-containing transition metal oxide as the positive electrode active material advantageously saves the production cost and increases the average discharge voltage. To increase the energy density of the battery 300, the positive electrode active material may include lithium nickel cobalt manganate. For example, the positive electrode active material may be Li(Ni,Co,Mn)O₂.

In the present disclosure, the notation “(A,B,C)” in a formula means “at least one selected from the group consisting of A, B, and C”. For example, “(Ni,Co,Al)” is synonymous with “at least one selected from the group consisting of Ni, Co, and Al”.

The positive electrode active material may include Li(Ni,Co,Mn)O₂. For example, the positive electrode active material may include lithium nickel cobalt manganate. The positive electrode active material having such a configuration can enhance the energy density and the charge-discharge efficiency of the battery 300.

The positive electrode active material may include LiNi_{0.6}Co_{0.2}Mn_{0.2}O₂. According to this configuration, the energy density and the charge-discharge efficiency of the battery 300 can be enhanced.

The positive electrode layer 35 may include a solid electrolyte. The solid electrolyte contained in the positive electrode layer 35 is written as the third solid electrolyte. According to this configuration, the positive electrode layer 35 can attain enhanced ion conductivity and thereby can offer enhanced output characteristics of the battery 300.

The third solid electrolyte that is used may be a halide solid electrolyte, a sulfide solid electrolyte, an oxide solid electrolyte, a polymeric solid electrolyte, or a complex hydride solid electrolyte.

The halide solid electrolyte, the sulfide solid electrolyte, the oxide solid electrolyte, the polymeric solid electrolyte, or the complex hydride solid electrolyte that is used may be a material described as the first solid electrolyte in Embodiment 1.

Specifically, the third solid electrolyte may contain Li, M, and X. Here, M is at least one selected from the group consisting of metal elements other than Li, and metalloid elements. X is at least one selected from the group consisting of F, Cl, Br, and I. According to this configuration, the third solid electrolyte can attain enhanced ion conductivity and thereby can offer enhanced output characteristics of the battery 300.

When the positive electrode 31 includes the electrode 100 or the electrode 200 and the positive electrode layer 35 includes the third solid electrolyte, the third solid electrolyte may not contain sulfur. This configuration can eliminate the generation of hydrogen sulfide gas and thus can enhance the safety of the battery 300.

When the positive electrode 31 includes the electrode 100 or the electrode 200 and the positive electrode layer 35 includes the third solid electrolyte, the first electrode layer 12 may have the first active material and the third solid electrolyte in contact with each other, and the second electrode layer 13 may have the second active material and the third solid electrolyte in contact with each other.

When the positive electrode layer 35 includes the third solid electrolyte, the positive electrode layer 35 may include particles of the third solid electrolyte.

When the negative electrode 32 includes the electrode 100 or the electrode 200, the negative electrode layer 37 may further include an active material other than the first active material and the second active material. The negative electrode layer 37 may include a negative electrode active material.

When the negative electrode 32 does not include the electrode 100 or the electrode 200, the negative electrode layer 37 may include only a negative electrode active material as the active material.

For example, the negative electrode active material includes a material capable of occluding and releasing metal ions, such as lithium ions.

Examples of the negative electrode active materials include metal materials, carbon materials, oxides, nitrides, tin compounds, and silicon compounds. The metal materials may be elemental metals. The metal materials may be alloys. Examples of the metal materials include lithium metal and lithium alloys. Examples of the carbon materials include natural graphite, cokes, semi-graphitized carbon, carbon fibers, spherical carbon, artificial graphite, and amorphous carbon. The capacity density of the battery 300 can be enhanced by using, for example, silicon (Si), tin (Sn), a silicon compound, or a tin compound.

The negative electrode layer 37 may further include a solid electrolyte. The solid electrolyte contained in the negative electrode layer 37 is written as the fourth solid electrolyte. According to this configuration, the negative electrode layer 37 can attain enhanced ion conductivity and thereby can offer enhanced output characteristics of the battery 300.

The fourth solid electrolyte that is used may be a halide solid electrolyte, a sulfide solid electrolyte, an oxide solid electrolyte, a polymeric solid electrolyte, or a complex hydride solid electrolyte.

The halide solid electrolyte, the sulfide solid electrolyte, the oxide solid electrolyte, the polymeric solid electrolyte, or the complex hydride solid electrolyte that is used may be a material described as the second solid electrolyte contained in the electrolyte layer 33.

When the negative electrode 32 includes the electrode 100 or the electrode 200 and the negative electrode layer 37 includes the fourth solid electrolyte, the first electrode layer 12 may have the first active material and the fourth solid electrolyte in contact with each other, and the second electrode layer 13 may have the second active material and the fourth solid electrolyte in contact with each other.

When the negative electrode layer 37 includes the fourth solid electrolyte, the negative electrode layer 37 may include particles of the fourth solid electrolyte.

The shapes of the third solid electrolyte that may be contained in the positive electrode layer 35 and of the fourth solid electrolyte that may be contained in the negative electrode layer 37 are not limited. For example, the shapes of the third solid electrolyte and the fourth solid electrolyte may be acicular, spherical, ellipsoidal, or fibers. For example, the shapes of the third solid electrolyte and the fourth solid electrolyte may be particulate. The third solid electrolyte and the fourth solid electrolyte may be formed to have a pellet or plate shape.

When the third solid electrolyte and the fourth solid electrolyte are particles (for example, spherical particles), the median diameters of the third solid electrolyte and the fourth solid electrolyte may be each greater than or equal to 0.1 μm and less than or equal to 100 μm. According to this configuration, the positive electrode active material and the third solid electrolyte may be favorably dispersed in the positive electrode layer 35, and the negative electrode active material and the fourth solid electrolyte may be favorably dispersed in the negative electrode layer 37. Thus, the battery 300 attains enhanced charge-discharge characteristics.

The median diameters of the third solid electrolyte and the fourth solid electrolyte may be each greater than or equal to 0.5 μm and less than or equal to 10 μm. According to this configuration, the positive electrode active material and the third solid electrolyte may be more favorably dispersed in the positive electrode layer 35, and the negative electrode active material and the fourth solid electrolyte may be more favorably dispersed in the negative electrode layer 37.

The shapes of the positive electrode active material and the negative electrode active material are not limited. For example, the shapes of the positive electrode active material and the negative electrode active material may be acicular, spherical, or ellipsoidal. For example, the shapes of the positive electrode active material and the negative electrode active material may be particulate.

When the positive electrode active material and the negative electrode active material are particles (for example, spherical particles), the median diameters of the positive electrode active material and the negative electrode active material may be each greater than or equal to 0.1 μm and less than or equal to 100 μm. When the median diameters of the positive electrode active material and the negative electrode active material are each greater than or equal to 0.1 μm, the positive electrode active material and the third solid electrolyte may be favorably dispersed in the positive electrode layer 35, and the negative electrode active material and the fourth solid electrolyte may be favorably dispersed in the negative electrode layer 37. Thus, the battery 300 attains enhanced charge-discharge characteristics. When the median diameters of the positive electrode active material and the negative electrode active material are each less than or equal to 100 μm, the lithium diffusion rate in the positive electrode layer 35 and the negative electrode layer 37 is enhanced, thus allowing the battery 300 to be operated at a high output.

The median diameters of the positive electrode active material and the negative electrode active material may be larger than the median diameters of the third solid electrolyte and the fourth solid electrolyte. According to this configuration, the positive electrode active material and the third solid electrolyte may be favorably dispersed in the positive electrode layer 35, and the negative electrode active material and the fourth solid electrolyte may be favorably dispersed in the negative electrode layer 37.

The thickness of the positive electrode 31 may be greater than or equal to 0.4 μm and less than or equal to 4000 μm. When the thickness of the positive electrode 31 is greater than or equal to 0.4 μm, a sufficient energy density of the battery 300 may be ensured. When the thickness of the positive electrode 31 is less than or equal to 4000 μm, the battery 300 may be operated at a high output.

The volume ratio “v3:100−v3” between the positive electrode active material and the third solid electrolyte contained in the positive electrode layer 35 may satisfy 5≤v3≤95. Here, v3 indicates the volume proportion of the positive electrode active material relative to the total volume of the positive electrode active material and the third solid electrolyte in the positive electrode layer 35 taken as 100. When 5≤v3 is satisfied, a sufficient energy density of the battery 300 may be ensured. When v3≤95 is satisfied, the battery 300 may be operated at a high output.

The volume ratio “v4:100−v4” between the negative electrode active material and the fourth solid electrolyte in the negative electrode layer 37 may satisfy 5≤v4≤95. Here, v4 indicates the volume proportion of the negative electrode active material relative to the total volume of the negative electrode active material and the fourth solid electrolyte in the negative electrode layer 37 taken as 100. When 5≤v4 is satisfied, a sufficient energy density of the battery 300 may be ensured. When v4≤95 is satisfied, the battery 300 may be operated at a high output.

At least one selected from the group consisting of the positive electrode layer 35, the electrolyte layer 33, and the negative electrode layer 37 may include a binder for the purpose of enhancing the adhesion of particles to one another. Binders are used to enhance the integrity of materials constituting an electrode. Examples of the binders include polyvinylidene fluoride, polytetrafluoroethylene, polyethylene, polypropylene, aramid resins, polyamide, polyimide, polyamidimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethylcellulose. Furthermore, the binder that is used may be a copolymer of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. A mixture of two or more materials selected from the above materials may also be used as the binder.

At least one of the positive electrode layer 35 or the negative electrode layer 37 may include a conductive auxiliary for the purpose of enhancing the electron conductivity. Examples of the conductive auxiliaries that may be used include graphites, such as natural graphites and artificial graphites; carbon blacks, such as acetylene blacks and Ketjen blacks; conductive fibers, such as carbon fibers and metal fibers; carbon fluoride; metal powders, such as aluminum; conductive whiskers, such as zinc oxide and potassium titanate; conductive metal oxides, such as titanium oxide; and conductive polymer compounds, such as polyaniline, polypyrrole, and polythiophene. The cost can be reduced by using a carbon conductive auxiliary as the conductive auxiliary.

Examples of the shapes of the batteries 300 include coin shapes, cylindrical shapes, prismatic shapes, sheet shapes, button shapes, flat shapes, and laminate shapes.

### Battery Manufacturing Methods

For example, the battery 300 may be manufactured by the following method. As an example, the method for manufacturing the battery 300 described below assumes that the negative electrode 32 is the electrode 100 in Embodiment 1.

The first electrode material and the second electrode material described in the method for producing the electrode 100 in Embodiment 1 are provided as materials for forming the negative electrode layer 37. The material for forming the electrolyte layer 33 is provided, and the positive electrode material is provided as a material for forming the positive electrode layer 35. Stainless-steel sheets are provided as the positive electrode current collector 34 and the negative electrode current collector 36.

By a known method, a laminated body is fabricated in which the negative electrode current collector 36, the negative electrode layer 37, the electrolyte layer 33, the positive electrode layer 35, and the positive electrode current collector 34 are arranged in this order. A battery 300 is thus obtained. The negative electrode layer 37 includes the first electrode layer 12 and the second electrode layer 13. The first electrode layer 12 is located on the negative electrode current collector 36 side, and the second electrode layer 13 is located on the electrolyte layer 33 side.

The third solid electrolyte contained in the positive electrode layer 35, and the second solid electrolyte contained in the electrolyte layer 33 may be produced by the same method as the method for producing the first solid electrolyte described in the method for producing the electrode 100 in Embodiment 1.

### Embodiment 4

Embodiment 4 will be described below with reference to FIG. 4. The same reference numerals are assigned to the same constituent members as in Embodiment 3, and detailed description thereof is omitted.

FIG. 4 is a sectional view illustrating a schematic configuration of a battery 400 according to Embodiment 4. The battery 400 has the same configuration as the battery 300 in Embodiment 3, except that the electrolyte layer 33 is replaced by a separator 43.

According to the above configuration, the battery 400 can satisfy both charge-discharge efficiency and discharge capacity. Furthermore, the battery 400 may attain a small change in average discharge voltage.

The separator 43 is arranged between the positive electrode layer 35 and the negative electrode layer 37 to prevent direct contact between the positive electrode layer 35 and the negative electrode layer 37. The separator 43 can sufficiently ensure the safety of the battery 400.

The separator 43 has lithium ion conductivity. The material for the separator 43 is not particularly limited as long as lithium ions can pass therethrough.

Examples of the materials for the separator 43 include porous materials. The separator 43 may have a film shape. The separator 43 may be a porous film. Examples of the porous films include woven fabrics, nonwoven fabrics, porous films made of polyolefin resins, and glass paper porous films obtained by weaving glass fibers into nonwoven fabrics.

The separator 43 may be impregnated with an electrolyte solution. According to this configuration, the battery 400 can satisfy both charge-discharge efficiency and discharge capacity.

The electrolyte solution may include at least one selected from the group consisting of cyclic ethers, glymes, and sulfolanes. The electrolyte solution may include an ether. Examples of the ethers include cyclic ethers and glycol ethers. The glycol ethers may be glymes represented by the formula CH₃(OCH₂CH₂)ₙOCH₃. In the formula, n is an integer greater than or equal to 1. The electrolyte solution may include a mixture of a cyclic ether and a glyme or may include a cyclic ether as the solvent.

Examples of the cyclic ethers include tetrahydrofuran (THF), 2-methyltetrahydrofuran (2MeTHF), 2,5-dimethyltetrahydrofuran, 1,3-dioxolane (1,3DO), and 4-methyl-1,3-dioxolane (4Me1,3DO). A single cyclic ether, or a mixture of two or more cyclic ethers selected from those described above may be used.

Examples of the glymes include monoglyme (1,2-dimethoxyethane), diglyme (diethylene glycol dimethyl ether), triglyme (triethylene glycol dimethyl ether), tetraglyme (tetraethylene glycol dimethyl ether), pentaethylene glycol dimethyl ether, and polyethylene glycol dimethyl ether. The glyme may be a mixture of tetraglyme and pentaethylene glycol dimethyl ether.

Examples of the sulfolanes include 3-methylsulfolane.

The electrolyte solution may include an electrolyte salt. Examples of the electrolyte salts include lithium salts, such as LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, LiClO₄, and lithium bisoxalatoborate. Lithium may be dissolved in the electrolyte solution.

### Battery Manufacturing Methods

The battery 400 has the same configuration as the battery 300 in Embodiment 3, except that the electrolyte layer 33 is replaced by the separator 43. Thus, the battery 400 may be obtained by replacing the electrolyte layer 33 with the separator 43 in the method for manufacturing the battery 300. The separator 43 may be impregnated with an electrolyte solution.

### Embodiment 5

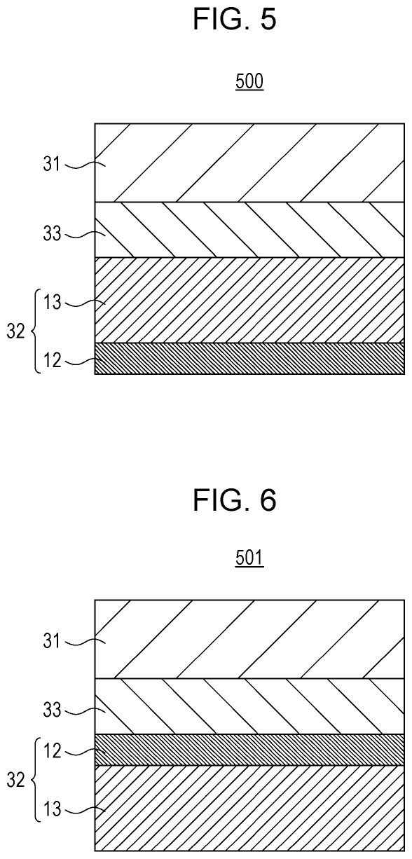

Embodiment 5 will be described below with reference to FIGS. 5 to 8. The same reference numerals are assigned to the same constituent members as in Embodiments 1 to 4, and detailed description thereof is omitted. FIGS. 5 to 8 omit the positive electrode current collector 34 in the positive electrode 31 and the negative electrode current collector 36 in the negative electrode 32.

FIG. 5 is a sectional view illustrating a schematic configuration of a battery 500 according to Embodiment 5.

The battery 500 includes a positive electrode 31, a negative electrode 32, and an electrolyte layer 33 arranged between the positive electrode 31 and the negative electrode 32. The positive electrode 31 includes a positive electrode active material. The negative electrode 32 includes a first electrode layer 12 as a first negative electrode layer and a second electrode layer 13 as a second negative electrode layer. Specifically, the first electrode layer 12 includes a first active material containing Mo and O as a first negative electrode active material. The second electrode layer 13 includes a second active material containing Li, Ti, and O as a second negative electrode active material.

In the battery 500, the ratio in percentage of the area occupied by the first active material in a cross section of the first electrode layer 12 to the area occupied by the positive electrode active material in a cross section of the positive electrode 31 is greater than or equal to 1% and less than or equal to 50%. The above ratio is calculated based on the results of measurement in which the area of a cross section of the positive electrode 31 is equal to the area of a cross section of the first electrode layer 12. That is, the main measurement conditions in the measurement of the area occupied by the positive electrode active material in a cross section of the positive electrode 31 are the same as the main measurement conditions under which the area occupied by the first active material in a cross section of the first electrode layer 12 is measured.

Japanese Unexamined Patent Application Publication No. 2021-34326 discloses an all-solid-state battery that includes lithium nickel cobalt manganese composite oxide as a positive electrode active material, lithium titanium oxide as a negative electrode active material, and a sulfide solid electrolyte. Lithium titanium oxide is characterized by its small expansion and contraction associated with insertion and extraction of lithium ions during charging and discharging. On the other hand, lithium nickel cobalt manganese composite oxide has a characteristic that it contracts during charging and expands during discharging. The expansion-contraction ratio varies depending on the composition of the lithium nickel cobalt manganese composite oxide but is generally greater than or equal to 1% and less than or equal to 8%. Thus, in a battery using lithium nickel cobalt manganese composite oxide as an active material, the expansion and contraction of the electrode during charging and discharging create gaps between the materials constituting the electrode, resulting in poor interfacial bonding. Thus, the discharge capacity is lowered, that is, cycle characteristics are deteriorated by repeated charging and discharging.

In the present embodiment, the first active material containing Mo and O has charge-discharge potentials close to those of the second active material containing Li, Ti, and O. Thus, the combined use of the first active material and the second active material does not significantly impair the shape of charge-discharge curves of the battery 500. Furthermore, the second active material containing Li, Ti, and O is characterized by its small expansion and contraction associated with insertion and extraction of lithium ions during charging and discharging. Thus, the second electrode layer 13 may enhance cycle characteristics of the battery 500. On the other hand, the first active material containing Mo and O has a characteristic that it contracts during charging and expands during discharging. That is, the first electrode layer 12 expands and contracts along with the expansion and contraction of the positive electrode 31 during charging and discharging, and thus serves to reduce the expansion and contraction of the battery 500 as a whole. Thus, the structure according to the above configuration is suited for enhancing cycle characteristics.

For example, the area occupied by the positive electrode active material in a cross section of the positive electrode 31, and the area occupied by the first active material in a cross section of the first electrode layer 12 may be calculated by the following method.

Elemental mapping is performed by SEM-EDX (scanning electron microscope-energy dispersive X-ray spectrometry). When, for example, the positive electrode active material is lithium nickel cobalt manganate, Ni, Co, and Mn elements are mapped. For the first active material, Mo and O elements are mapped. The SEM image is compared with the elemental mapping image. In this manner, for example, pixels in the sectional SEM image of the positive electrode 31 are assigned to the positive electrode active material and to other substances, and pixels in the sectional SEM image of the first electrode layer 12 are assigned to the first active material and to other substances. The pixel identification may be performed with an image analysis software. The total number of the pixels assigned to the positive electrode active material is taken as the area occupied by the positive electrode active material in the cross section of the positive electrode 31. The total number of the pixels assigned to the first active material is taken as the area occupied by the first active material in the cross section of the first electrode layer 12. The pixel counting may be performed with an image analysis software.

For example, the SEM-EDX measurement conditions are 7 kV electron beam acceleration voltage and ×10000 magnification. For example, the area occupied by the positive electrode active material in a cross section of the positive electrode 31, and the area occupied by the first active material in a cross section of the first electrode layer 12 may be calculated based on the results of measurement with respect to fields of observation determined by the SEM-EDX measurement conditions.

The area occupied by the positive electrode active material in a cross section of the positive electrode 31 may be determined in such a manner that a plurality of cross sections at different locations (for example, cross sections at three locations) of the positive electrode 31 are analyzed by the aforementioned method, and the total numbers of the pixels assigned to the positive electrode active material are averaged. The area occupied by the first active material in a cross section of the first electrode layer 12 may be determined in such a manner that a plurality of cross sections at different locations (for example, cross sections at three locations) of the first electrode layer 12 are analyzed by the aforementioned method, and the total numbers of the pixels assigned to the first active material are averaged.

The above ratio may be greater than or equal to 1% and less than or equal to 30% or may be greater than or equal to 10% and less than or equal to 20%. According to this configuration, cycle characteristics can be further enhanced.

The above ratio may be regarded as the ratio of the volume occupied by the first active material in the first electrode layer 12 to the volume occupied by the positive electrode active material in the positive electrode 31.

That is, the ratio of the volume occupied by the first active material in the first electrode layer 12 to the volume occupied by the positive electrode active material in the positive electrode 31 may be greater than or equal to 1% and less than or equal to 50%. The ratio of the volume occupied by the first active material in the first electrode layer 12 to the volume occupied by the positive electrode active material in the positive electrode 31 may be greater than or equal to 1% and less than or equal to 30% or may be greater than or equal to 10% and less than or equal to 20%.

The ratio of the area occupied by the first active material in a cross section of the first electrode layer 12 to the area occupied by the positive electrode active material in a cross section of the positive electrode 31 may be designed so that the volume by which the first active material expands and contracts is approximately equal to the volume by which the positive electrode active material expands and contracts. That is, the first active material may be used in an appropriate amount in accordance with the expansion-contraction ratio of the positive electrode active material.

The ratio of the mass of the first solid electrolyte to the mass of the first electrode layer 12 may be less than or equal to 30%. The ratio of the mass of the first solid electrolyte to the mass of the first electrode layer 12 may be less than or equal to 5%. This configuration eliminates or reduces the occurrence of gaps between the first active material and the first solid electrolyte by the expansion and contraction of the first active material.

The first electrode layer 12 may be substantially free from the first solid electrolyte. The phrase “substantially free from the first solid electrolyte” means that the first solid electrolyte is not added intentionally and the ratio of the mass of the first solid electrolyte to the mass of the first electrode layer 12 is, for example, less than or equal to 0.1%, typically less than or equal to 0.01%. The same applies to other materials. The above configuration more effectively eliminates or reduces the occurrence of gaps between the first active material and the first solid electrolyte by the expansion and contraction of the first active material. Thus, cycle characteristics can be further enhanced.

When the first electrode layer 12 is substantially free from the first solid electrolyte, the shape of the first active material may be, for example, a thin film formed by such a method as a gas-phase method.

In the present embodiment, the second electrode layer 13 is arranged between the electrolyte layer 33 and the first electrode layer 12. According to this configuration, cycle characteristics of the battery 500 can be enhanced. Specifically, the second electrode layer 13 is in contact with both the electrolyte layer 33 and the first electrode layer 12.

In the negative electrode 32, the first electrode layer 12 and the second electrode layer 13 may be in direct contact.

The ratio of the charge capacity of the first electrode layer 12 to the charge capacity of the second electrode layer 13 may be less than or equal to 0.4. The ratio of the charge capacity of the first electrode layer 12 to the charge capacity of the second electrode layer 13 reflects the content of the first active material relative to the content of the second active material in the negative electrode 32. The above configuration ensures that the first active material will exhibit its characteristic appropriately, specifically, the first active material will not contract excessively during charging and will not expand excessively during discharging. Thus, cycle characteristics can be further enhanced.

### Battery Manufacturing Methods

For example, the battery 500 may be manufactured by the following method. The first solid electrolyte may be produced by the method described in Embodiment 1.

The first electrode material is provided as a material for forming the first electrode layer 12. The first active material may be used as the first negative electrode material. That is, the first electrode material may be substantially free from the first solid electrolyte. The first electrode material that is used may be a mixture of the first active material and the first solid electrolyte. In this case, the ratio of the mass of the first solid electrolyte to the mass of the first electrode material may be less than or equal to 30% or may be less than or equal to 5%.

The second electrode material is provided as a material for forming the second electrode layer 13. The second electrode material is obtained by mixing the second active material and the first solid electrolyte. The second active material and the first solid electrolyte may be mixed in any manner without limitation. For example, the second active material and the first solid electrolyte may be mixed using a tool, such as a mortar, or the second active material and the first solid electrolyte may be mixed using a mixing device, such as a ball mill. The second active material and the first solid electrolyte may be mixed in any ratio without limitation.

The first electrode material and the second electrode material are provided as materials for forming the negative electrode 32. An electrolyte layer material is provided as a material for forming the electrolyte layer 33, and a positive electrode material is provided as a material for forming the positive electrode 31. The electrolyte layer material that is used may be the second solid electrolyte. The positive electrode material that is used may be a mixture of the positive electrode active material and the third solid electrolyte. Stainless-steel sheets are provided as the positive electrode current collector and the negative electrode current collector.

The third solid electrolyte contained in the positive electrode material, and the second solid electrolyte contained in the electrolyte layer material may be produced by the same method as the method for producing the first solid electrolyte described hereinabove.

By a known method, a laminated body is fabricated in which the negative electrode 32, the electrolyte layer 33, and the positive electrode 31 are arranged in this order. A battery 500 is thus obtained. The negative electrode 32 includes the first electrode layer 12 and the second electrode layer 13. In the present embodiment, the second electrode layer 13 is located on the electrolyte layer 33 side, and the first electrode layer 12 is located on the negative electrode current collector side.

In the above embodiment, the second electrode layer 13 is arranged between the electrolyte layer 33 and the first electrode layer 12. However, the configuration of the negative electrode 32 is not limited thereto.

FIG. 6 is a sectional view illustrating a schematic configuration of a battery 501 in Modification 1. In Modification 1, the first electrode layer 12 is arranged between the electrolyte layer 33 and the second electrode layer 13. This configuration too can enhance cycle characteristics of the battery 501. In the present modification, the first electrode layer 12 is in contact with both the electrolyte layer 33 and the second electrode layer 13.

The negative electrode 32 may have a structure in which the first electrode layers 12 and/or the second electrode layers 13 are alternately laminated a plurality of times. In the negative electrode 32, the first electrode layers 12 and/or the second electrode layers 13 may be laminated one time, or two or more times.

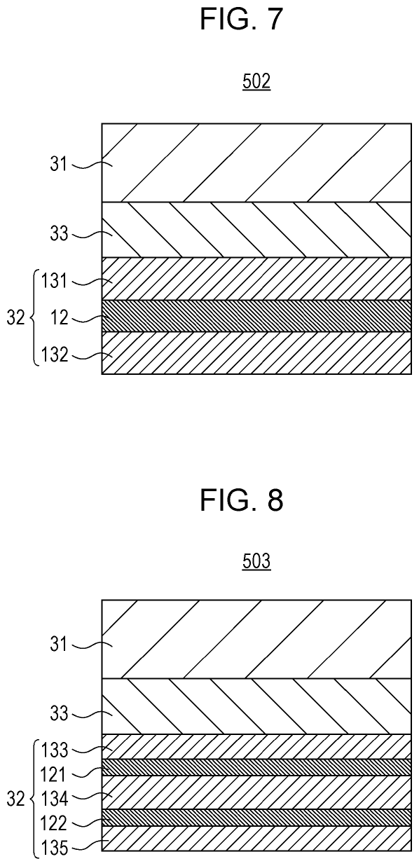

FIG. 7 is a sectional view illustrating a schematic configuration of a battery 502 in Modification 2. In Modification 2, the first electrode layer 12 is arranged between a second electrode layer 131 and a second electrode layer 132. This configuration too can enhance cycle characteristics of the battery 502.

FIG. 8 is a sectional view illustrating a schematic configuration of a battery 503 in Modification 3. In Modification 3, a first electrode layer 121 is arranged between a second electrode layer 133 and a second electrode layer 134, and a first electrode layer 122 is arranged between the second electrode layer 134 and a second electrode layer 135. This configuration too can enhance cycle characteristics of the battery 503.

When the negative electrode 32 has a structure in which the first electrode layers 12 and/or the second electrode layers 13 are alternately laminated a plurality of times, the compositions of the first active materials contained in the first electrode layers 12 may be the same as or different from one another. Furthermore, the compositions of the second active materials contained in the second electrode layers 13 may be the same as or different from one another.

### Embodiment 6

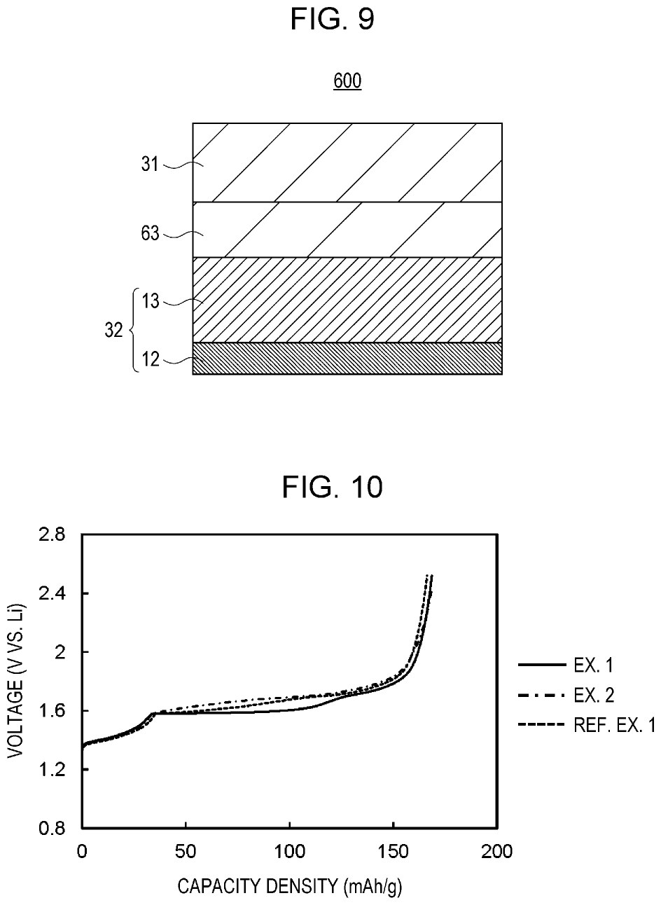

Embodiment 6 will be described below with reference to FIG. 9. Descriptions overlapping with those in Embodiment 5 are omitted as appropriate. FIG. 9 omits the positive electrode current collector 34 in the positive electrode 31, and the negative electrode current collector 36 in the negative electrode 32.

FIG. 9 is a sectional view illustrating a schematic configuration of a battery 600 according to Embodiment 6. The battery 600 has the same configuration as the battery 500 in Embodiment 5 except that the electrolyte layer 33 is replaced by a separator 63.

The above configuration too can enhance cycle characteristics of the battery 600.

The separator 63 that is used may be the same as the separator 43 described in Embodiment 4.

### Battery Manufacturing Methods

The battery 600 has the same configuration as the battery 500 in Embodiment 5 except that the electrolyte layer 33 is replaced by the separator 63. Thus, the battery 600 is obtained by replacing the electrolyte layer 33 with the separator 63 in the method for manufacturing the battery 500. The separator 63 may be impregnated with an electrolyte solution.

In the above embodiment, the second electrode layer 13 is arranged between the separator 63 and the first electrode layer 12. However, the configuration of the negative electrode 32 is not limited thereto. The negative electrode 32 may have a structure in which the first electrode layers 12 and/or the second electrode layers 13 are alternately laminated a plurality of times. In the negative electrode 32, the first electrode layers 12 and/or the second electrode layers 13 may be laminated one time, or two or more times. The structures of Modifications 1 to 3 described in Embodiment 5 may be similarly applied to the battery 600.

### EXAMPLES

The present disclosure will be described in detail below based on EXAMPLES and REFERENCE EXAMPLES. EXAMPLES 1 and 2 below illustrate examples in which batteries are the batteries 300 according to Embodiment 3. EXAMPLES 3 and 4 below illustrate examples in which batteries are the batteries 500 according to Embodiment 5.

The EXAMPLES below are only illustrative and do not limit the scope of the present disclosure thereto.

First, the discharge capacity and the charge-discharge efficiency of batteries were evaluated using EXAMPLES 1 and 2 and REFERENCE EXAMPLE 1.

### Example 1

### Preparation of First Solid Electrolyte

In an argon atmosphere having a dew point of less than or equal to −60° C. (hereinafter, written as “dry argon atmosphere”), ingredient powders LiBr, LiCl, LiI, YCl₃, and YBr₃ were weighed out so that the molar ratio Li:Y:Br:Cl:I would be 3:1:2:2:2. The ingredient powders were pulverized and mixed in a mortar to give a mixture.

Subsequently, the mixture was milled using a planetary ball mill (P-7 manufactured by Fritsch Japan Co., Ltd.) at 600 rpm for 25 hours. Thus, a powder of Li₃YBr₂Cl₂I₂ was obtained as a first solid electrolyte of EXAMPLE 1.

### Preparation of First Electrode Material

MoO₂ (manufactured by Kojundo Chemical Lab. Co., Ltd.) was used as a first active material. Vapor-grown carbon fibers (VGCF-H manufactured by Showa Denko K.K.) were used as a conductive auxiliary. In a dry argon atmosphere, the first solid electrolyte of EXAMPLE 1, the first active material, and the conductive auxiliary were weighed out so that the mass ratio would be 20.4:78.4:1.2. These materials were mixed in a mortar. Thus, a first electrode material of EXAMPLE 1 was obtained. “VGCF” is a registered trademark of Showa Denko K.K.

### Preparation of Second Electrode Material

Li₄Ti₅O₁₂ (manufactured by Toshima Manufacturing Co., Ltd.) was used as a second active material. Vapor-grown carbon fibers (VGCF-H manufactured by Showa Denko K.K.) were used as a conductive auxiliary. In a dry argon atmosphere, the first solid electrolyte of EXAMPLE 1, the second active material, and the conductive auxiliary were weighed out so that the mass ratio would be 32.3:65.8:1.9. These materials were mixed in a mortar. Thus, a second electrode material of EXAMPLE 1 was obtained.

### Fabrication of Battery

Solid electrolyte Li₆PS₅Cl (manufactured by MSE Supplies LLC) was used as a material for forming an electrolyte layer. 5.4 mg of the first electrode material, 7.6 mg of the second electrode material, and 80 mg of Li₆PS₅Cl were weighed out. The first electrode material, the second electrode material, and Li₆PS₅Cl were laminated in this order in an electrically insulating external cylinder and were compacted at 720 MPa. Thus, a first laminated body was fabricated that had a first electrode layer, a second electrode layer, and an electrolyte layer in this order. Next, In metal with a thickness of 200 μm, Li metal with a thickness of 300 μm, and In metal with a thickness of 200 μm were arranged in this order on the electrolyte layer of the first laminated body. The unit was pressed at a pressure of 80 MPa to give a second laminated body composed of the first electrode layer, the second electrode layer, the electrolyte layer, and an In—Li—In layer. Next, stainless-steel current collectors were arranged on both sides of the second laminated body, and current collector leads were attached to the current collectors. Lastly, the inside of the electrically insulating external cylinder was isolated from the outside atmosphere and was sealed with use of an electrically insulating ferrule. A battery of EXAMPLE 1 was thus fabricated. In the battery of EXAMPLE 1, the negative electrode had a structure illustrated in FIG. 1.

### Example 2

### Fabrication of Battery

A battery of EXAMPLE 2 was fabricated in the same manner as in EXAMPLE 1, except that the second electrode material, the first electrode material, and Li₆PS₅Cl were laminated in this order in the electrically insulating external cylinder. In the battery of EXAMPLE 2, the negative electrode had a structure illustrated in FIG. 2.

### Reference Example 1

### Preparation of Electrode Material

MoO₂ (manufactured by Kojundo Chemical Lab. Co., Ltd.) was used as a first active material. Li₄Ti₅O₁₂ (manufactured by Toshima Manufacturing Co., Ltd.) was used as a second active material. Vapor-grown carbon fibers (VGCF-H manufactured by Showa Denko K.K.) were used as a conductive auxiliary. In a dry argon atmosphere, the first solid electrolyte of EXAMPLE 1, the first active material, the second active material, and the conductive auxiliary were weighed out so that the mass ratio would be 27.4:38.5:32.6:1.6. These materials were mixed in a mortar. Thus, an electrode material of REFERENCE EXAMPLE 1 was obtained.

### Fabrication of Battery

13.0 mg of the electrode material and 80 mg of Li₆PS₅Cl were weighed out. The electrode material and Li₆PS₅Cl were laminated in this order in an electrically insulating external cylinder and were compacted at 720 MPa. Thus, a first laminated body composed of an electrode and an electrolyte layer was fabricated. Except for this, a battery of REFERENCE EXAMPLE 1 was fabricated in the same manner as in EXAMPLE 1. In the battery of REFERENCE EXAMPLE 1, the first active material and the second active material were mixed in the electrode.

### Charge-Discharge Test

Next, the batteries of EXAMPLES 1 and 2 and REFERENCE EXAMPLE 1 were subjected to a charge-discharge test under the following conditions.

The battery was placed in a thermostatic chamber at 25° C. The battery was charged at a constant current of 170 μA. The charging was terminated when the potential vs. Li reached 1.0 V. Next, the battery was discharged at a constant current of 170 μA, and the discharging was terminated when the potential vs. Li reached 2.5 V. Based on the results of the charge-discharge test described above, the discharge capacity in 170 μA discharging was obtained, and the charge-discharge efficiency in 170 μA charging and discharging was calculated. The results are described in Table 1.

FIG. 10 is a graph illustrating the results of the battery discharge test. In FIG. 10, the ordinate indicates voltage and the abscissa indicates discharge capacity. The voltage values shown in FIG. 10 are versus Li. Based on FIG. 10, the average discharge voltage was calculated. The average discharge voltage is the average of the voltages during the period when the discharge capacity is between 0% and 80% relative to the discharge capacity at the end of discharging taken as 100%. The results are described in Table 1.

TABLE 1

| | | Charge- | |
|---|---|---|---|
| | Discharge | discharge | |
| | capacity in | efficiency in | Average |
| | 170 μA | 170 μA charging | discharge |
| | discharging | and discharging | voltage |
| | (mAh/g) | (%) | (V) |
| EXAMPLE 1 | 168.6 | 95.4 | 1.57 |
| EXAMPLE 2 | 169.5 | 95.3 | 1.62 |
| REFERENCE | 166.2 | 93.6 | 1.59 |
| EXAMPLE 1 | | | |

### Discussion

The electrodes in EXAMPLES 1 and 2 included the first active material in the first electrode layer and the second active material in the second electrode layer. As described in Table 1, the batteries of EXAMPLES 1 and 2 had high values of discharge capacity and charge-discharge efficiency, and their structures were suited for satisfying both charge-discharge efficiency and discharge capacity. The batteries of EXAMPLES 1 and 2 outperformed in discharge capacity and charge-discharge efficiency the battery of REFERENCE EXAMPLE 1 in which the first active material and the second active material were mixed in a single electrode layer. When the first active material and the second active material are mixed in a single electrode layer as is the case in REFERENCE EXAMPLE 1, the active materials are sometimes not dispersed well in the electrode layer. In contrast, the first active material and the second active material in EXAMPLES 1 and 2 were not mixed in a single electrode layer, and the active materials were most likely dispersed favorably in the respective layers, namely, the first electrode layer and the second electrode layer. Probably because of this, the charge-discharge efficiency was optimized in each of the first electrode layers and the second electrode layers in EXAMPLES 1 and 2, and both charge-discharge efficiency and discharge capacity were satisfied as a result.

From the above results, it can be seen that a separate electrode layer that includes the first active material containing Mo and O, and a separate electrode layer that includes the second active material containing Li, Ti, and O can constitute an electrode structure together suited for satisfying both charge-discharge efficiency and discharge capacity.

As illustrated in FIG. 10, the discharge curve of EXAMPLE 1 had a flatter region (plateau) in the first half, and the change in discharge voltage was small compared to the discharge curves of REFERENCE EXAMPLE 1 and EXAMPLE 2. This is understandable from the fact that the average discharge voltage of EXAMPLE 1 is lower than the average discharge voltages of REFERENCE EXAMPLE 1 and EXAMPLE 2. It is known that a battery using an active material containing Li, Ti, and O has a small change in discharge potential during discharging. It is also a known fact that a battery using an active material containing Mo and O has a larger change in discharge potential during discharging than a battery using an active material containing Li, Ti, and O. Li transfers from the positive electrode toward the negative electrode. In EXAMPLE 1, a plateau region appeared in the first half of the discharge curve probably because the second electrode layer including Li₄Ti₅O₁₂ as the second active material was arranged closer to the electrolyte layer. In this manner, the change in discharge potential in the first half of discharging was suppressed, and consequently the battery of EXAMPLE 1 attained a small change in operating voltage. Furthermore, the average discharge voltage of the battery of EXAMPLE 1 was lower than the average discharge voltages of the batteries of REFERENCE EXAMPLE 1 and EXAMPLE 2. The voltage measured in EXAMPLES is a voltage versus an In—Li negative electrode. The electrode of the present disclosure is usable as a negative electrode more advantageously with decreasing voltage versus an In—Li negative electrode, that is, with decreasing average discharge voltage.

From the above results, it can be seen that the change in average discharge voltage can be suppressed by providing the first active material containing Mo and O and the second active material containing Li, Ti, and O as separate electrode layers, and arranging the second electrode layer including the second active material on the side closer to the electrolyte layer.

Next, cycle characteristics of batteries were evaluated using EXAMPLES 3 and 4 and REFERENCE EXAMPLE 2.

### Example 3

### Preparation of First Solid Electrolyte

The first solid electrolyte of EXAMPLE 1 was used.

### Preparation of First Electrode Material

MoO₂ (manufactured by Kojundo Chemical Lab. Co., Ltd.) was used as a first active material. This first active material was used as a first electrode material of EXAMPLE 3.

### Preparation of Second Electrode Material

Li₄Ti₅O₁₂ (manufactured by Toshima Manufacturing Co., Ltd.) was used as a second active material. Vapor-grown carbon fibers (VGCF-H manufactured by Showa Denko K.K.) were used as a conductive auxiliary. In a dry argon atmosphere, the first solid electrolyte of EXAMPLE 1, the second active material, and the conductive auxiliary were weighed out so that the mass ratio would be 42.7:51.3:6.0. These materials were mixed in a mortar. Thus, a second electrode material of EXAMPLE 3 was obtained.

### Preparation of Positive Electrode Material

LiNi_{0.6}Co_{0.2}Mn_{0.2}O₂ was used as a positive electrode active material. Vapor-grown carbon fibers were used as a conductive auxiliary. In a dry argon atmosphere, the first solid electrolyte of EXAMPLE 1, the positive electrode active material, and the conductive auxiliary were weighed out so that the mass ratio would be 39.0:60.0:1.0. These materials were mixed in a mortar. Thus, a positive electrode material of EXAMPLE 3 was obtained.

### Preparation of Electrolyte Layer Material

Solid electrolyte Li₆PS₅Cl (manufactured by MSE Supplies LLC) was used as a electrolyte layer material of EXAMPLE 3.

### Fabrication of Battery

2.3 mg of the first electrode material, 24.0 mg of the second electrode material, 80 mg of the electrolyte layer material, and 18.5 mg of the positive electrode material were weighed out. The first electrode material, the second electrode material, the electrolyte layer material, and the positive electrode material were laminated in this order in an electrically insulating external cylinder and were compacted at 720 MPa. Thus, a first laminated body was fabricated that had a first electrode layer, a second electrode layer, an electrolyte layer, and a positive electrode in this order. Next, stainless-steel current collectors were arranged on both sides of the first laminated body, and current collector leads were attached to the current collectors. Lastly, the inside of the electrically insulating external cylinder was isolated from the outside atmosphere and was sealed with use of an electrically insulating ferrule. A battery of EXAMPLE 3 was thus fabricated. In the battery of EXAMPLE 3, the negative electrode had a structure illustrated in FIG. 1.

### Example 4

### Fabrication of Battery

A battery of EXAMPLE 4 was fabricated in the same manner as in EXAMPLE 3 except for the following. 4.6 mg of the first electrode material, 18.7 mg of the second electrode material, 80 mg of the electrolyte layer material, and 18.5 mg of the positive electrode material were weighed out. The first electrode material, the second electrode material, the electrolyte layer material, and the positive electrode material were laminated in this order in an electrically insulating external cylinder and were compacted at 720 MPa. Thus, a first laminated body was fabricated that had a first electrode layer, a second electrode layer, an electrolyte layer, and a positive electrode in this order. In the battery of EXAMPLE 4, the negative electrode had a structure illustrated in FIG. 1.

### Reference Example 2

### Fabrication of Battery

A battery of REFERENCE EXAMPLE 2 was fabricated in the same manner as in EXAMPLE 3 except for the following. 29.3 mg of the second electrode material, 80 mg of the electrolyte layer material, and 18.5 mg of the positive electrode material were weighed out. The second electrode material, the electrolyte layer material, and the positive electrode material were laminated in this order in an electrically insulating external cylinder and were compacted at 720 MPa. Thus, a first laminated body was fabricated that had a second electrode layer, an electrolyte layer, and a positive electrode in this order.

### Charge-Discharge Test

Next, the batteries of EXAMPLES 3 and 4 and REFERENCE EXAMPLE 2 were subjected to a charge-discharge test under the following conditions.

The battery was placed in a thermostatic chamber at 25° C. The battery was charged at a constant current of 210 μA. The charging was terminated when the potential vs. Li reached 2.75 V. Next, the battery was discharged at a constant current of 210 μA. The discharging was terminated when the potential vs. Li reached 0.9 V.

The above charging and discharging are defined as one cycle. In the charge-discharge test, 20, 30, 40, 50, and 60 cycles of the above charging and discharging were performed. The discharge capacity of the battery at the first cycle was defined as the initial discharge capacity, and the ratio of the discharge capacity of the battery after the predetermined number of cycles to the initial discharge capacity was defined as the discharge capacity retention rate (%). The discharge capacity retention rate may be used as an index of cycle characteristics of the battery.

Table 2 describes the discharge capacity retention rates (%) of the batteries of EXAMPLES 3 and 4 and REFERENCE EXAMPLE 2. Table 2 also describes the ratios (100×(Aₙ₁/Aₚ)) (%) of the area Aₙ₁ occupied by the first active material in a sectional SEM image of the first electrode layer to the area Aₚ occupied by the positive electrode active material in a sectional SEM image of the positive electrode as determined by the method described hereinabove, the ratios (C₂:C₁) of the charge capacity C₂ of the second electrode layer to the charge capacity C₁ of the first electrode layer, and the ratios (C₁/C₂) of the charge capacity C₁ of the first electrode layer to the charge capacity C₂ of the second electrode layer. Incidentally, the charge capacity C₁ of the first electrode layer and the charge capacity C₂ of the second electrode layer were determined by charging a half-cell composed of the first electrode layer or the second electrode layer and lithium metal as the counter electrode until the voltage reached 1.0 V.

TABLE 2

| | | Discharge capacity retention rate (%) | | |
|---|---|---|---|---|
| | | REFERENCE | | |
| | | EXAMPLE 2 | EXAMPLE 3 | EXAMPLE 4 |
| Number | 1 | 100 | 100 | 100 |
| of | 20 | 95.9 | 100.9 | 95.8 |
| cycles | 30 | 95.7 | 100.6 | 95.1 |
| | 40 | 95.2 | 100.2 | 95.1 |
| | 50 | 94.9 | 100.2 | 95.5 |
| | 60 | 94.6 | 100.0 | 96.4 |

| | | | |
|---|---|---|---|
| 100 × (Aₙ₁/Aₚ) (%) | 0 | 15 | 30 |
| C₂:C₁ | 3.6:0 | 3.0:0.6 | 2.3:1.3 |
| C₁/C₂ | — | 0.20 | 0.57 |

### Discussion

The electrodes of EXAMPLES 3 and 4 included the first active material in the first electrode layer and the second active material in the second electrode layer. As described in Table 2, the batteries of EXAMPLES 3 and 4 retained the discharge capacity at a high retention rate even after 60 cycles. In particular, EXAMPLE 3 in which the ratio (100×(Aₙ₁/Aₚ)) was 15% resulted in 100% discharge capacity retention rate even after 60 cycles and attained good and stable cycle characteristics. This is probably because the first electrode layer expanded and contracted along with the expansion and contraction of the positive electrode active material during charging and discharging, and thereby good interfacial bonding between the particles was maintained. In EXAMPLE 4, the discharge capacity retention rate after 60 cycles was slightly lower than that in EXAMPLE 3. This is probably because the ratio (100×(Aₙ₁/Aₚ)) in EXAMPLE 4 was higher than that in EXAMPLE 3, and the larger amount of the first active material led to relatively easy occurrence of gaps between the materials constituting the first electrode layer by repeated charging and discharging.

In EXAMPLE 3, the ratio (C₁/C₂) of the charge capacity C₁ of the first electrode layer to the charge capacity C₂ of the second electrode layer satisfied the range of less than or equal to 0.4. Probably because of this, EXAMPLE 3 was particularly successful in allowing the first active material to exhibit its characteristic appropriately; specifically, the first active material did not contract excessively during charging and did not expand excessively during discharging.

The expansion-contraction ratio of the first active material is about 16%. The expansion-contraction ratio of the positive electrode active material LiNi_{0.6}Co_{0.2}Mn_{0.2}O₂ is about 2%. From the above results, it can be seen that a structure suited for enhancing cycle characteristics can be provided by introducing an appropriate amount of the first active material into the first electrode layer in accordance with the expansion-contraction ratio of the positive electrode active material contained in the positive electrode.

For example, the battery of the present disclosure may be used as an all-solid-state lithium secondary battery.

What is claimed is:

1. An electrode comprising;
a current collector;
a first electrode layer including a first active material containing Mo and O; and
a second electrode layer including a second active material containing Li, Ti, and O, wherein
at least one selected from the group consisting of the first electrode layer and the second electrode layer includes a solid electrolyte.

2. The electrode according to claim 1, comprising:
the current collector;
the first electrode layer; and
the second electrode layer in this order.

3. The electrode according to claim 1, comprising:
the current collector;
the second electrode layer; and
the first electrode layer in this order.

4. The electrode according to claim 1, wherein
the first active material comprises molybdenum oxide.

5. The electrode according to claim 4, wherein
the molybdenum oxide comprises MoO₂.

6. The electrode according to claim 1, wherein
the second active material comprises lithium titanium oxide.

7. The electrode according to claim 6, wherein
the lithium titanium oxide comprises Li₄Ti₅O₁₂.

8. The electrode according to claim 1, wherein
the solid electrolyte contains Li, M, and X,
M is at least one selected from the group consisting of metal elements other than Li, and metalloid elements, and
X is at least one selected from the group consisting of F, Cl, Br, and I.

9. The electrode according to claim 8, wherein
the solid electrolyte is represented by following formula (1):
Li_{α}M_{β}X_{γ} Formula (1)
wherein α, β, and γ are each independently a value greater than 0.

10. The electrode according to claim 9, wherein
the solid electrolyte comprises Li₃YBr₂Cl₂I₂.

11. The electrode according to claim 8, wherein
the solid electrolyte does not contain sulfur.

12. A battery comprising:
a positive electrode;
a negative electrode; and
an electrolyte layer arranged between the positive electrode and the negative electrode, wherein
the positive electrode or the negative electrode comprises the electrode according to claim 1.

13. The battery according to claim 12, wherein
the positive electrode comprises a positive electrode active material,
the negative electrode comprises the first electrode layer and the second electrode layer, and
the ratio of the area occupied by the first active material in a cross section of the first electrode layer to the area occupied by the positive electrode active material in a cross section of the positive electrode is greater than or equal to 1% and less than or equal to 50%.

14. The battery according to claim 13, wherein
the ratio is greater than or equal to 1% and less than or equal to 30%.

15. The battery according to claim 14, wherein
the ratio is greater than or equal to 10% and less than or equal to 20%.

16. The battery according to claim 13, wherein
the ratio of the charge capacity of the first electrode layer to the charge capacity of the second electrode layer is less than or equal to 0.4.

17. The battery according to claim 13, wherein
the positive electrode active material comprises lithium nickel cobalt manganate.

18. The battery according to claim 17, wherein
the positive electrode active material comprises LiNi_{0.6}Co_{0.2}Mn_{0.2}O₂.

19. The battery according to claim 12, wherein
the positive electrode includes a solid electrolyte,
the solid electrolyte contains Li, M, and X,
M is at least one selected from the group consisting of metal elements other than Li, and metalloid elements, and
X is at least one selected from the group consisting of F, Cl, Br, and I.
